(19) United States
(12) Patent Application Publication
(10) Pub. No.: US 2011/0032986 A1
(43) Pub. Date: Feb. 10, 2011

(54) SYSTEMS AND METHODS FOR AUTOMATICALLY CONTROLLING THE RESOLUTION OF STREAMING VIDEO CONTENT

(75) Inventors: Shashidhar Banger, Bangalore (IN); Laxminarayana Madhusudana Dalimba, Bangalore (IN); Anant M. Kulkarni, Karnataka (IN)

Correspondence Address: INGRASSIA FISHER & LORENZ, P.C. (EchoStar), 7010 E. COCHISE ROAD, SCOTTSDALE, AZ, 85253, US

(73) Assignee: SLING MEDIA PVT LTD, Bangalore (IN)

(21) Appl. No.: 12/537,785

(22) Filed: Aug. 7, 2009

(51) Int. Cl. H04B 1/66

(52) U.S. Cl. 375/240.07

(57) ABSTRACT

Systems and methods are described for automatically controlling the resolution of video content that is streaming over a data connection. Video content frames are generated that each have a predetermined frame resolution and comprise video data encoded at an encoding resolution. The video content frames are transmitted over a network, and one or more conditions of the network are sensed. The encoding resolution of the video data is selectively adjusted in each video content frame in response to the one or more sensed network conditions.

### TECHNICAL FIELD

The present disclosure generally relates to techniques for automatically controlling the resolution of video content that is streaming over a data connection.

### BACKGROUND

The capability to transmit and receive streaming video content over a network is becoming increasingly popular, in both for professional and personal environments. To transmit streaming video content over a network to a client device, the video content is first encoded at a particular bit rate and in a particular resolution, and is then transmitted (or “streamed”) to a client device, at a streaming bit rate, over a network. The client device decodes the video content and renders it on a display at the encoded resolution.

As is generally known, the viewing quality of streaming video content depends upon its resolution, which is dependent on the streaming bit rate. Thus, if the streaming bit rate is reduced while streaming video content is being viewed, then the viewing quality, for a given resolution, will be concomitantly reduced. There may be times when video content is being streamed to a client device via a connection that has a fluctuating bit rate. During such times it may not be possible to stream relatively high quality video, resulting in an undesirable experience at the client end. In some environments, for example, a Wi-Fi environment, the bit rate variation can be relatively inconsistent, ranging at times from 500 kbps to 5000 kbps. Relatively minor network data rate fluctuations can be accommodated by adjusting the encoding bit rate or video frame rate. However, for relatively high bit rate fluctuations, there is a need for resolution change for good user experience.

Many software applications that implement or facilitate the streaming of video content allow for the specification of the streaming resolution. With such applications, whenever there is resolution change, new video configuration information is transmitted to the receiver(s), which is used to reconfigure the receiver decoder(s) and rendering system(s). These operations may result in disturbances in the output video.

It is therefore desirable to create systems and methods for automatically controlling the resolution of video content that is transmitted over a network or other data connection. These and other desirable features and characteristics will become apparent from the subsequent detailed description and the appended claims, taken in conjunction with the accompanying drawings and this background section.

### BRIEF SUMMARY

According to various exemplary embodiments, systems and methods are described for automatically controlling the resolution of video content that is streaming over a data connection. In an exemplary method, video content frames are generated that comprise video data also encoded at a first resolution. The video content frames are transmitted to a network. One or more conditions of the network are determined and feedback data representative of the network are generated. The feedback data are processed to determine whether to change the resolution of the video data. Updated video content frames are selectively generated after the processing of the feedback data. Each updated video content frame has the first resolution and comprises video content data encoded at a second resolution. The updated video content frames are transmitted to the network.

In another exemplary method, video content frames are generated that each have a predetermined frame resolution and comprise video data encoded at an encoding resolution. The video content frames are transmitted over a network, and one or more conditions of the network are sensed. The encoding resolution of the video data is selectively adjusted in at least one video content frame in response to the one or more sensed network conditions.

In other exemplary embodiments, a system for automatically controlling the resolution of streaming video content includes a network streamer and encoding engine. The network streamer is configured to receive video content frames and transmit the video content frames to a network. The encoding engine is configured to receive video data and to receive feedback data representative of network bandwidth. The encoding engine is further configured, upon receipt of the video data and the feedback data, to generate video content frames that each have a predetermined frame resolution and comprise video data encoded at an encoding resolution that is consistent with the network bandwidth, determine region of interest coordinates that correspond to the encoding resolution, generate region of interest data representative of the determined region of interest coordinates, and multiplex the region of interest data with a single one of the video content frames.

Furthermore, other desirable features and characteristics of the media aggregator system and method will become apparent from the subsequent detailed description and the appended claims, taken in conjunction with the accompanying drawings and the preceding background.

### BRIEF DESCRIPTION OF THE DRAWING FIGURES

Exemplary embodiments will hereinafter be described in conjunction with the following drawing figures, wherein like numerals denote like elements, and wherein:

FIG. 1 is a block diagram of an exemplary media encoding system;

FIG. 2 is a flowchart of an exemplary process for automatically controlling the encoding resolution of video content; and

FIG. 3 depicts a plurality of individual frames of video content.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

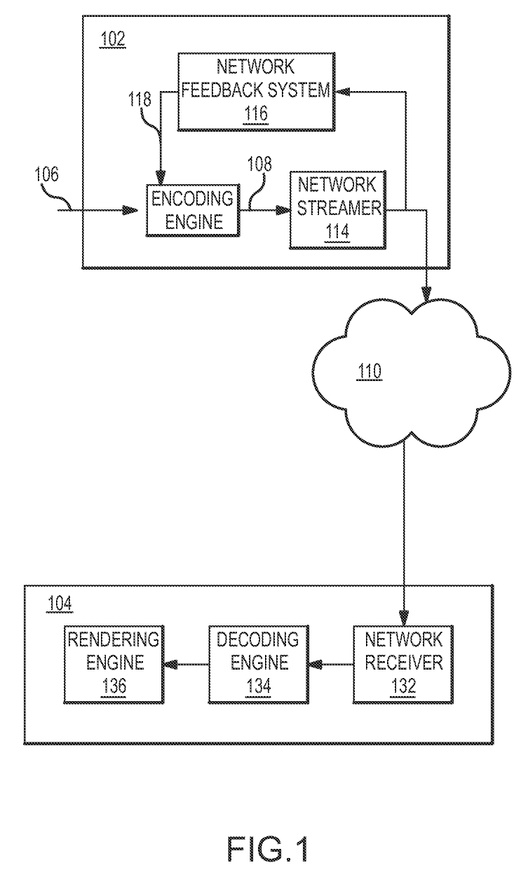

Turning now to the drawing figures and with initial reference to FIG. 1, an exemplary system 100 for automatically controlling the resolution of streaming video content is depicted and includes a streaming server 102 and a client 104. The streaming server 102 is configured to receive frames of video data 106, generate video content frames 108 that include encoded video data, and transmit (or “stream”) the video content frames 108 to the client device 104 via a network 110. A particular exemplary embodiment of the streaming server 102 will now be described in more detail.

The streaming server 102 may be variously implemented and configured, but in the depicted embodiment includes at least an encoding engine 112, a network streamer 114, and a network feedback module 116. The encoding engine 112 receives frames of captured video data 106, which may be supplied from any one of numerous suitable video image capture devices or various other suitable sources. The encoding engine 112 also receives feedback data 118 from the network feedback module 116. The encoding engine 112, in response to the feedback data 118, generates the video content frames 108. The generated video content frames 108 each have a predetermined framed resolution (or streaming resolution), and comprise video data encoded at an encoding resolution that is consistent with the bandwidth of the network 110.

It will be appreciated that the encoding engine 112 may be implemented in hardware (e.g., a digital signal processor or other integrated circuit used for media encoding), software (e.g., software or firmware programming), or combinations thereof. The encoding engine 112 is therefore any feature that receives video data, encodes or transcodes the received video data into a desired format, and generates the video content frames 108 at the predetermined frame resolution for transmission onto the network 110. Although FIG. 1 depicts a single encoding engine 112, the streaming server 102 may include a plurality of encoding engines 112, if needed or desired.

It will additionally be appreciated that the encoding engine 112 may be configured to encode the video data into any one or more of numerous suitable formats, now known or developed in the future. Some non-limiting examples of presently known suitable formats include the WINDOWS MEDIA format available from the Microsoft Corporation of Redmond, Wash., the QUICKTIME format, REALPLAYER format, the MPEG format, and the FLASH video format, just to name a few. No matter the specific format(s) that is (are) used, the encoding engine 112 transmits the video content frames 108 to the network streamer 114.

The network streamer 114 receives the video content frames 108 and transmits each onto the network 110. The network streamer 114 may be any one of numerous suitable devices that are configured to transmit (or “stream”) the video content frames 108 onto the network 110. The network streamer 114 may be implemented in hardware, software and/or firmware, or various combinations thereof. In various embodiments, the network streamer 114 preferably implements suitable network stack programming, and may include suitable wired or wireless network interfaces.

The network feedback module 116 is in operable communication with the network 110 and the encoding engine 112. The network feedback module 116 is configured to sense one or more conditions of the network 110 (or channel thereof). The specific number and type of network conditions that are sensed may vary, but preferably include (or are representative of) at least the current bandwidth of the network 110 (or channel), as seen by the network streamer 112. The network feedback module 116 is additionally configured to generate feedback data 118 that are representative of the network bandwidth and, as noted above, supply the feedback data 118 to the encoding engine 112. It will be appreciated that the depicted configuration is merely exemplary, and that in some embodiments the network feedback module 116 may alternatively implement its functionality using data received from the network streamer 112 or data received from the client 104. It will additionally be appreciated that the network feedback module 116 may be implemented in hardware, software and/or firmware, or various combinations thereof.

The encoding engine 112, as was alluded to above, is responsive to the feedback data 118 supplied from the network feedback module 116 to selectively adjust the encoding resolution of the video data in each video content frame 108 to more suitably match the network bandwidth. For example, if the network feedback module 116 senses that the bandwidth of the network 110 has decreased, the encoding engine 112 will automatically decrease the encoding resolution of the video data in each video content frame 108. It is noted, however, that the resolution of each video content frame 108 preferably remains constant, at the predetermined frame resolution, regardless of network bandwidth. The encoding engine 112 may additionally multiplex data with one or more video content frames 108. The meaning and purpose of the multiplexed data, which are referred to herein as region of interest data, will be described further below.

The client device 104 is in operable communication with the streaming server 102, via the network 110, and receives the video content frames 108. The client device 104 is configured, upon receipt of each video content frame 108, to decode the encoded video data. The client device 104 is also configured to upscale the decoded video data, if needed, to the predetermined frame resolution, and to render the decoded video data at the predetermined resolution. To implement this functionality, the depicted client device 104 includes a network receiver 132, a decoding engine 134, and a rendering engine 136. As will be described further below, the client device 104 may also, based on the above-mentioned region of interest data that the streaming server 102 multiplexes with one or more video content frames 108, upscale the decoded video data so that any resolution change, if made, is transparent to a user of the client device 104.

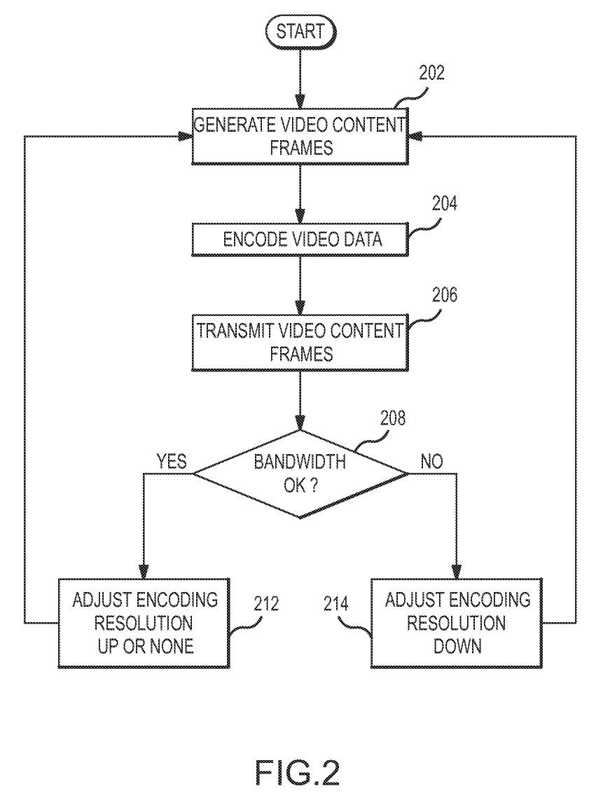

Turning now to FIG. 2, an exemplary method 200, implemented in the streaming server 102 for automatically controlling the resolution of video content to be transmitted onto the network 110, is depicted in flowchart form, and will now be described. In doing so, it is noted that in the proceeding descriptions the parenthetical numeric references refer to like numbered blocks in the depicted flowchart.

The streaming server 102, upon receipt of frames of video data 106, generates video content frames 108 (202), and encodes the video data of each video content frame 108 at an encoding resolution (204). As has been repeatedly stated herein, each video content frame 108 comprises the encoded video data and has the predetermined frame resolution. It is noted that, at least initially, the encoding resolution is preferably the same as the predetermined frame resolution. It is additionally noted that one or more of the video content frames 108 are also multiplexed with region of interest data. The video content frames 108 are then transmitted onto the network (206), while one or more conditions of the network are sensed (208). Based on the sensed network condition(s), the encoding resolution of the encoded video data in each video content frame 108 may be adjusted. More specifically, if the sensed network condition(s) indicate that the bandwidth of the network 110 is sufficient, the encoding engine 112 will continue to (or once again, as the case may be) encode the video data 106 at the predetermined frame resolution (212). If, however, the sensed network condition(s) indicate(s) that the bandwidth of the network 110 has decreased to a point that quality video cannot be supplied at this resolution, the encoding engine 112 will begin to encode the video data 106 at an encoding resolution that is lower than the predetermined frame resolution (214). This lower resolution encoding of the video data 106 will continue, at least until the bandwidth of the network 110 is once again sufficient to support a higher encoding resolution.

The encoding resolution of the video data 106 in each video content frame 108 may be correlated to what is referred to herein as a region of interest or more specifically, a region of interest within a video content frame 108. In a particular preferred embodiment, this region of interest within a video content frame 108 comprises region of interest coordinates that correspond to the encoding resolution of the video data 106. It will thus be appreciated that the region of interest data that may be multiplexed with a video content frame 108 are representative of these region of interest coordinates.

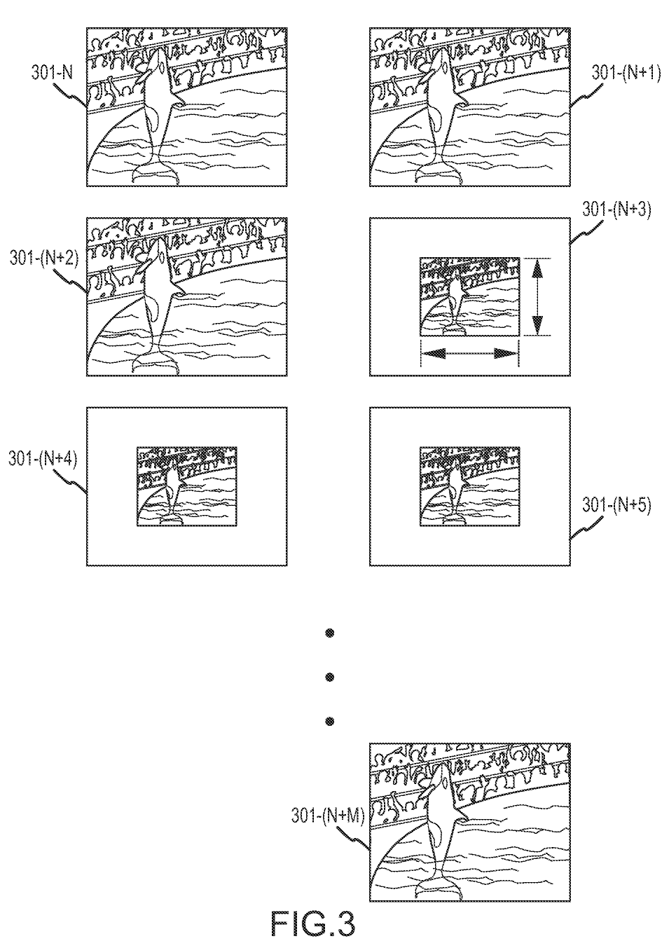

To more clearly illustrate the above described process 200 and the associated region or interest, reference should now be made to FIG. 3. A sequence of exemplary video content frames 108, sequentially referenced as 301-N, 301-(N+1), 301-(N+2) . . . , 301-(N+M), are depicted in FIG. 3. In this example, the encoding engine 112 initially implements an encoding resolution of the video data 106 that is equal to the predetermined frame resolution (e.g., W×H). Hence, the region of interest within the initially generated video content frames corresponds to the entirety of the initially generated video content frames 108. The region of interest coordinates are, as illustrated: top-left (o, o) and bottom right (W, H); and the region of interest data are concomitantly representative of these coordinates. Preferably, the region interest data are multiplexed only with the initial video content frame 301-N, and not with 301-(N+1), 302-(n+2), and so on.

As FIG. 3 further depicts, after video content frame 301-(N+2) is generated, the network feedback module 116 has sensed that the network bandwidth has decreased to a point that quality video cannot be supplied at this resolution. As a result, the encoding resolution of the video data 106 is lowered to a resolution (w×h) that is less than the predetermined frame resolution (e.g., w×h<W×H), and video content frames 301-(N+3), 301-(N+4), 301-(N+5), . . . 301-(N+R) are thereafter generated. More specifically, and as is explicitly illustrated in Frame 301-(N+3), when the network bandwidth decreases, new region of interest coordinates that correspond to the lowered encoding resolution are determined, and as illustrated are: top-left [((W−w)/2), ((H−h)/2)) and bottom right [((W−w/2)+w), ((H−h)/2)+h). Moreover, region of interest data are generated that are representative of these coordinates. As FIG. 3 depicts, the regions outside of the new region of interest will be black. As a result, the encoding overhead is minimal.

Preferably, the region interest data are multiplexed only with content frame 301-(N+3), and not with 301-(N+4), 302-(N+5), and so on. It is undesirable for a user at the client 104 to see the change in video resolution. So, as was noted above, the region of interest data are used at the client 104 to appropriately upscale the decoded video data to the original resolution (e.g., M×N). The video content frames will continue to stream in this manner until, for example, the network bandwidth improves. At such time, the encoding engine 112 may decide to once again encode the video data 106 at the predetermined frame resolution, and the video content frames will look as shown in Frame 301-(N+M).

As a specific numeric example of the generalized process described above, assume the streaming resolution from the server 102 to the client 104 is 640×480. While streaming the video content frames 108, a reduction in the network bandwidth is detected. If the reduction is sufficient, such that a lower encoding resolution (e.g., 320×240) of the video data 106 may provide a better quality viewing experience at the client device 104, the server computer 102 will change the encoding resolution of the video data and multiplex the corresponding region of interest data with each video content frame 108. For a lower encoding resolution 320×240, the corresponding region of interest coordinates might be: top-left (160,120) and bottom-right: (480, 360).

The term “exemplary” is used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is claimed is:

1. A method of automatically controlling the resolution of streaming video content, the method comprising the steps of:
generating video content frames, each video content frame comprising video data encoded at a first resolution;
transmitting the video content frames to a network;
determining one or more conditions of the network and generating feedback data representative of the network;
processing the feedback data to determine whether to change the resolution of the video data;
selectively generating updated video content frames after the processing of the feedback data, each updated video content frame having the first resolution and comprising video content data encoded at a second resolution; and
transmitting the updated video content frames to the network.

2. The method of claim 1, further comprising:
receiving, via the network, the updated video content frames;
decoding the video data of each of the updated video content frames; and
upscaling the decoded video data to the first resolution.

3. The method of claim 2, further comprising:
rendering the upscaled video data at the first resolution.

4. The method of claim 1, further comprising:
determining region of interest coordinates that correspond to the second resolution;
generating region of interest data representative of the determined region of interest coordinates; and
multiplexing the region of interest data with a single one of the updated video content frames.

5. The method of claim 4, further comprising:
receiving, via the network, the single one of the updated video content frames that is multiplexed with the region of interest data;
demultiplexing the region of interest data from the single one of the updated video content frames;
decoding the video data from the single one of the of the updated video content frames; and
upscaling the decoded video data to the first resolution using the region of interest data.

6. The method of claim 5, further comprising:
receiving, via the network, updated video content frames transmitted subsequent to the single one of the updated video content frames;
decoding the video data from each of the received updated video content frames; and
upscaling the decoded video data to the first resolution using the region of interest data.

7. The method of claim 6, further comprising:
rendering the upscaled video data at the first resolution.

8. A method of controlling the resolution of streaming video content, the method comprising the steps of:
generating video content frames having a predetermined frame resolution, each video content frame comprising video data encoded at an encoding resolution;
transmitting the video content frames over a network;
determining one or more conditions of the network; and
selectively adjusting the encoding resolution of the video data in at least one video content frame in response to the network conditions.

9. The method of claim 8, further comprising:
receiving, via the network, the video content frames;
decoding the encoded video data;
selectively upscaling the decoded video data to predetermined frame resolution; and
rendering the decoded and upscaled video data at the predetermined frame resolution.

10. The method of claim 8, further comprising:
determining region of interest coordinates that correspond to the adjusted encoding resolution;
generating region of interest data representative of the determined region of interest coordinates; and
multiplexing the region of interest data with a single one of the video content frames.

11. The method of claim 10, further comprising:
receiving, via the network, the single one of the video content frames multiplexed with the region of interest data;
demultiplexing the region of interest data from the single one of the video content frames;
decoding the video data from the single one of the video content frames; and
upscaling the decoded video data to the predetermined frame resolution using the region of interest data; and
rendering the decoded and upscaled video data at the predetermined frame resolution.

12. The method of claim 11, further comprising:
receiving, via the network, video content frames transmitted subsequent to the single one of the updated video content frames;
decoding the video data from each of the received video content frames; and
upscaling the decoded video data to the predetermined frame resolution using the region of interest data; and
rendering the decoded and upscaled video data at the predetermined frame resolution.

13. A system for controlling the resolution of streaming video content, comprising:
a network streamer configured to receive video content frames and transmit the video content frames to a network; and
an encoding engine configured to receive video data and to receive feedback data representative of network bandwidth, the encoding engine further configured, upon receipt of the video data and the feedback data, to:
(i) generate video content frames that each have a predetermined frame resolution and comprise video data encoded at an encoding resolution that is consistent with the network bandwidth,
(ii) determine region of interest coordinates that correspond to the encoding resolution,
(iii) generate region of interest data representative of the determined region of interest coordinates, and
(iv) multiplex the region of interest data with a single one of the video content frames.

14. The system of claim 13, further comprising:
a network feedback module in operable communication with the encoding engine, the network feedback module configured to receive data representative of network bandwidth and, upon receipt thereof, to supply the feedback data to the encoding engine.

15. The system of claim 13, further comprising:
a client device coupled to receive the video content frames transmitted onto the network and configured, upon receipt thereof, to decode the encoded video data.

16. The system of claim 15, wherein the client device is further configured to (i) selectively upscale the decoded video data to the predetermined frame resolution and (ii) render the decoded and upscaled video data at the predetermined frame resolution.

17. The system of claim 13, further comprising:
a client device coupled to receive the video content frames transmitted to the network and configured, upon receipt thereof, to decode the encoded video data.

18. The system of claim 17, wherein the client device is further configured to (i) demultiplex the region of interest data from the single frame of the encoded video content and (ii) selectively upscale the decoded video content to a higher resolution using the region of interest data.

19. The system of claim 18, wherein the client device comprises:
a rendering engine configured to render the decoded and selectively upscaled video content.
